(19) United States
(12) Patent Application Publication
(10) Pub. No.: US 2026/0065771 A1
(43) Pub. Date: Mar. 5, 2026

(54) SYSTEM

(71) Applicant: SoftBank Group Corp., Tokyo (JP)

(72) Inventor: Takayuki TSUKADA, Tokyo (JP)

(21) Appl. No.: 19/304,740

(22) Filed: Aug. 20, 2025

(30) Foreign Application Priority Data
Aug. 30, 2024 (JP) 2024-149745

(51) Int. Cl. G08B 25/01; G06V 40/16; G06V 40/20; G08B 21/02; G08B 21/04

(52) U.S. Cl. CPC G08B 25/016; G06V 40/174; G06V 40/20; G08B 21/0208; G08B 21/0283; G08B 21/0423

(57) ABSTRACT

The system according to the embodiment comprises a recording unit, a transmission unit, an analysis unit, and a notification unit. The recording unit records video of a user wearing a wearable camera. The transmission unit transmits the video recorded by the recording unit to a cloud server. The analysis unit analyzes the video transmitted by the transmission unit and detects abnormal behavior or dangerous situations. The notification unit notifies the user's family or related parties of abnormalities or dangerous situations detected by the analysis unit.

### CROSS-REFERENCE TO RELATED APPLICATION

The present application claims priority to and incorporates by reference the entire contents of Japanese Patent Application No. 2024-149745 filed in Japan on Aug. 30, 2024.

### BACKGROUND OF THE INVENTION

### Field of the Invention

The technology of this disclosure relates to a system.

### Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem in that the user's safety is not sufficiently monitored in real time, and abnormalities or dangerous situations are not detected and notified promptly.

### SUMMARY OF THE INVENTION

The system according to the embodiment comprises a recording unit, a transmission unit, an analysis unit, and a notification unit. The recording unit records video of a user wearing a wearable camera. The transmission unit transmits the video recorded by the recording unit to a cloud server. The analysis unit analyzes the video transmitted by the transmission unit and detects abnormal behavior or dangerous situations. The notification unit notifies the user's family or related parties of abnormalities or dangerous situations detected by the analysis unit.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor with a sign (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) with a sign is a memory where information is temporarily stored and used as a work memory by the processor.

In the following embodiments, a storage with a sign is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) with a sign is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

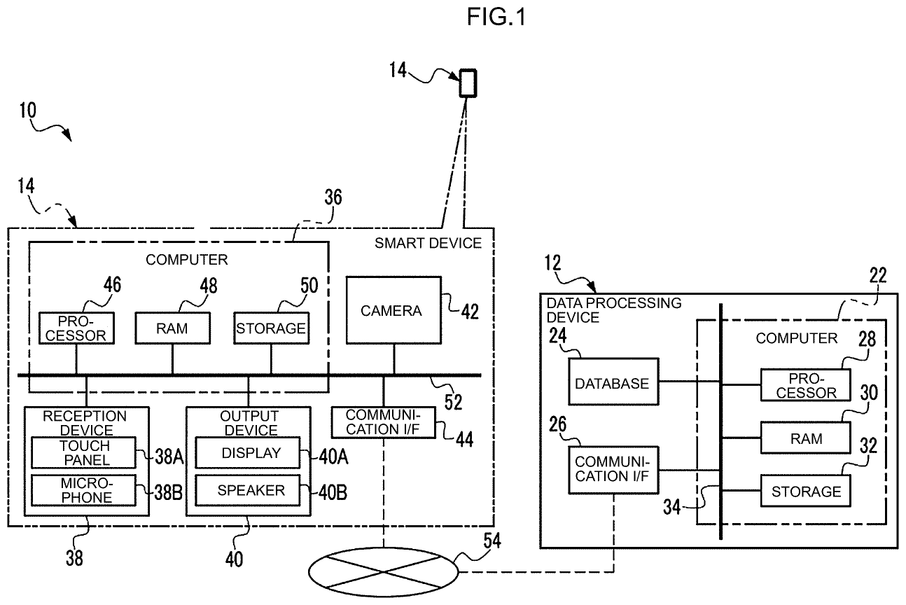

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

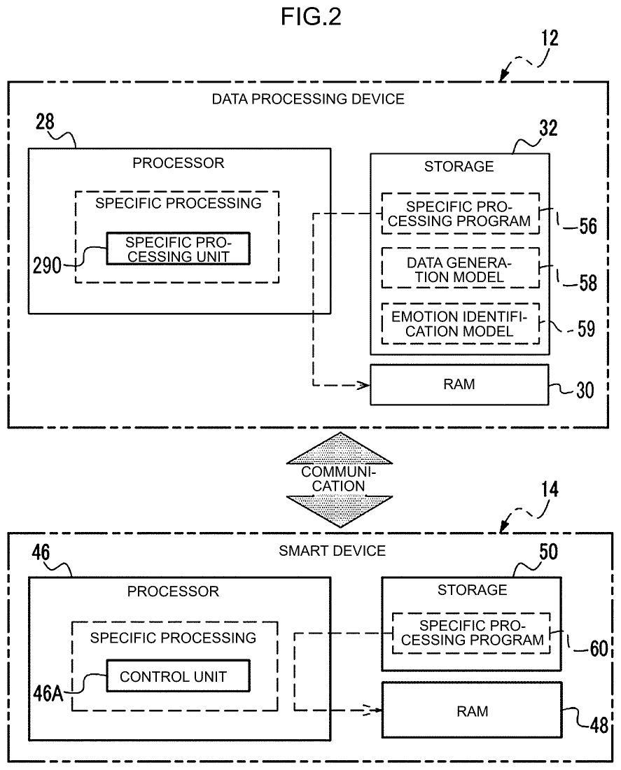

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1 of the Embodiment

The wearable camera system according to the embodiment of the present invention is a system for crime prevention and for addressing wandering and missing elderly persons. In this wearable camera system, the user wears a wearable camera and, during daily life, records video in real time from the user's point of view and transmits it to a cloud server. The cloud server analyzes the transmitted video and detects abnormal behavior or dangerous situations. For example, this includes cases where a child is approached by a suspicious person or an elderly person leaves a specific area. The detected abnormalities or dangerous situations are immediately notified to the user's family or related parties. This enables prompt response, thereby achieving crime prevention and ensuring the safety of the elderly. For example, a user wearing a wearable camera goes about daily life. This camera records video in real time from the user's point of view and transmits it to a cloud server. For example, it may be worn when a child goes to school or when an elderly person goes for a walk. Next, the cloud server analyzes the transmitted video. Using generative AI, abnormal behavior or dangerous situations in the video are detected. For example, this includes cases where a child is approached by a suspicious person or an elderly person leaves a specific area. The generative AI analyzes the movement and location information of persons in the video to detect abnormalities. The detected abnormalities or dangerous situations are immediately notified to the user's family or related parties. For example, notifications are sent via a smartphone application. This allows family members or related parties to respond quickly. For example, if a child is approached by a suspicious person, the family can immediately report it to the police. Also, if an elderly person leaves a specific area, the family can immediately start a search. Through this mechanism, crime prevention and ensuring the safety of the elderly are achieved. By wearing a wearable camera, the user's actions are constantly monitored, which deters suspicious persons from committing crimes. In addition, the risk of elderly persons wandering and going missing is reduced. For example, if an elderly person wearing a wearable camera leaves a specific area, the family can immediately identify the location and respond quickly. Thus, the wearable camera system enables crime prevention and ensuring the safety of the elderly by recording, transmitting, analyzing, and notifying the user's video.

The wearable camera system according to the embodiment comprises a recording unit, a transmission unit, an analysis unit, and a notification unit. The recording unit records video of a user wearing a wearable camera. For example, the recording unit records video in real time from the user's point of view. For example, the recording unit is worn when a child goes to school or when an elderly person goes for a walk. The transmission unit transmits the video recorded by the recording unit to a cloud server. For example, the transmission unit transmits video data to the cloud server in real time. The transmission unit can also estimate the user's emotions and adjust the timing of video transmission based on the estimated emotions. The analysis unit analyzes the video transmitted by the transmission unit and detects abnormal behavior or dangerous situations. For example, the analysis unit uses generative AI to analyze the movement and location information of persons in the video and detect abnormalities. For example, the analysis unit detects abnormalities when a child is approached by a suspicious person or when an elderly person leaves a specific area. The analysis unit can also estimate the user's emotions and adjust the priority of analysis based on the estimated emotions. The notification unit notifies the user's family or related parties of abnormalities or dangerous situations detected by the analysis unit. For example, the notification unit sends notifications via a smartphone application. The notification unit can also estimate the user's emotions and adjust the urgency of notifications based on the estimated emotions. Thus, the wearable camera system enables crime prevention and ensuring the safety of the elderly by recording, transmitting, analyzing, and notifying the user's video.

The recording unit can record video in real time from the user's point of view. Real time may include, for example, a delay time of less than one second, but is not limited to such examples. For example, the recording unit records video in real time from the user's point of view. For example, the recording unit records video in real time from the user's point of view. For example, the recording unit records video in real time from the user's point of view. By recording video in real time from the user's point of view, more accurate situational awareness can be achieved.

The analysis unit can analyze the movement and location information of persons in the video and detect abnormalities. Movements may include, for example, speed, direction, patterns, etc., but are not limited to such examples. Location information may include, for example, GPS, Wi-Fi location information, etc., but is not limited to such examples. For example, the analysis unit analyzes the movement and location information of persons in the video and detects abnormalities. For example, the analysis unit analyzes the movement and location information of persons in the video and detects abnormalities. For example, the analysis unit analyzes the movement and location information of persons in the video and detects abnormalities. By analyzing the movement and location information of persons in the video, abnormal behavior or dangerous situations can be detected quickly.

The notification unit can send notifications via a smartphone application. The smartphone application may include, for example, notification functions, alert functions, etc., but is not limited to such examples. For example, the notification unit sends notifications via a smartphone application. For example, the notification unit sends notifications via a smartphone application. For example, the notification unit sends notifications via a smartphone application. By sending notifications via a smartphone application, family members or related parties can respond quickly.

The recording unit can be worn when a child goes to school or when an elderly person goes for a walk. Children may include, for example, minors, specific age groups, etc., but are not limited to such examples. Elderly persons may include, for example, those aged 65 or older, 75 or older, etc., but are not limited to such examples. For example, the recording unit is worn when a child goes to school. For example, the recording unit is worn when an elderly person goes for a walk. For example, the recording unit is worn when a child goes to school. By wearing the device when children or elderly persons perform specific actions, safety is improved.

The analysis unit can detect abnormalities when a child is approached by a suspicious person or when an elderly person leaves a specific area. Suspicious persons may include, for example, strangers, specific behavior patterns, etc., but are not limited to such examples. Specific areas may include, for example, the area around the home, designated safe areas, etc., but are not limited to such examples. For example, the analysis unit detects abnormalities when a child is approached by a suspicious person. For example, the analysis unit detects abnormalities when an elderly person leaves a specific area. For example, the analysis unit detects abnormalities when a child is approached by a suspicious person. By detecting specific abnormal behaviors, prompt response is enabled.

The recording unit can analyze the user's behavior patterns during recording and automatically start recording when a specific behavior occurs. Behavior patterns may include, for example, daily routines, specific actions, etc., but are not limited to such examples. For example, the recording unit automatically starts recording when the user enters a specific area. For example, the recording unit automatically starts recording when the user performs a specific gesture. For example, the recording unit automatically starts recording when the user performs a specific action at a specific time of day. By automatically starting recording when a specific behavior occurs, important scenes can be reliably recorded.

The recording unit can simultaneously record surrounding audio during recording and synchronize the video and audio. Surrounding audio may include, for example, types of microphones, voice recognition technology, etc., but is not limited to such examples. For example, the recording unit records video and audio simultaneously and synchronizes them for playback later. For example, the recording unit analyzes surrounding audio in real time and emphasizes important audio for recording. For example, the recording unit automatically synchronizes video and audio to ensure seamless playback. By synchronizing video and audio, more accurate situational awareness can be achieved.

The recording unit can simultaneously record the user's location information during recording and link the video with the location information. Location information may include, for example, GPS, Wi-Fi location information, etc., but is not limited to such examples. For example, the recording unit records GPS data together with the video and displays the location information during playback. For example, the recording unit records the user's movement route and plays it back linked with the video. For example, the recording unit emphasizes and records location information when the user enters a specific area. By linking video and location information, the location can be displayed during playback.

The recording unit can simultaneously record the user's health status (such as heart rate and body temperature) during recording and issue an alert if an abnormality is detected. Health status may include, for example, heart rate, body temperature, blood pressure, etc., but is not limited to such examples. For example, the recording unit issues an alert if the user's heart rate is abnormally high. For example, the recording unit issues an alert if the user's body temperature is abnormally low. For example, the recording unit immediately issues an alert if the user's health status changes suddenly. By monitoring the user's health status, prompt response is possible when an abnormality is detected.

The transmission unit can adjust the compression rate of video data during transmission to optimize the transmission speed. Compression rate may include, for example, bit rate, compression algorithms, etc., but is not limited to such examples. For example, the transmission unit adjusts the compression rate according to network conditions to ensure optimal transmission speed. For example, the transmission unit adjusts the compression rate according to the importance of the video to ensure that necessary information is reliably transmitted. For example, the transmission unit adjusts the compression rate according to the user's emotions to provide an appropriate transmission speed. By adjusting the compression rate of video data, optimal transmission speed can be ensured.

The transmission unit can select the transmission route in consideration of the load status of the destination cloud server during transmission. Load status may include, for example, CPU usage, memory usage, etc., but is not limited to such examples. For example, if the cloud server is heavily loaded, the transmission unit transmits to another server. For example, the transmission unit monitors the load status of the cloud server in real time and selects the optimal transmission route. For example, the transmission unit uses multiple cloud servers and transmits while performing load balancing. By considering the load status of the cloud server, the optimal transmission route can be selected.

The transmission unit can select the transmission method in consideration of the user's network connection status during transmission. Network connection status may include, for example, Wi-Fi signal strength, mobile data speed, etc., but is not limited to such examples. For example, if Wi-Fi is available, the transmission unit prioritizes Wi-Fi for transmission. For example, if the mobile data connection is stable, the transmission unit uses mobile data for transmission. For example, the transmission unit automatically selects the optimal transmission method according to the network connection status. By selecting the optimal transmission method according to the network connection status, stable transmission is possible.

The transmission unit can encrypt video data during transmission to ensure data security during transmission. Encryption may include, for example, encryption algorithms such as AES, RSA, etc., but is not limited to such examples. For example, the transmission unit encrypts video data before transmission to protect data during transmission. For example, the transmission unit uses encryption algorithms to protect data during transmission from third parties. For example, the transmission unit automatically encrypts and decrypts video data to ensure security. By encrypting video data, data security during transmission can be ensured.

The analysis unit can perform object recognition in the video during analysis and issue an alert when a specific object appears in the video. Object recognition may include, for example, image recognition algorithms, definitions of specific objects, etc., but is not limited to such examples. For example, the analysis unit issues an alert when a suspicious object appears in the video. For example, the analysis unit issues an alert when a specific person appears in the video. For example, the analysis unit issues an alert when a dangerous object appears in the video. By performing object recognition in the video, an alert can be issued promptly when a specific object appears.

The analysis unit can perform audio analysis in the video during analysis and detect specific audio patterns. Audio patterns may include, for example, screams, the sound of breaking glass, etc., but are not limited to such examples. For example, the analysis unit detects screams in the video and issues an alert. For example, the analysis unit detects abnormal audio patterns in the video and issues an alert. For example, the analysis unit detects specific audio patterns in the video and issues an alert. By performing audio analysis in the video, specific audio patterns can be detected and responded to promptly.

The analysis unit can detect abnormalities in consideration of environmental information in the video during analysis. Environmental information may include, for example, weather, time of day, temperature, etc., but is not limited to such examples. For example, the analysis unit detects abnormalities in consideration of weather information in the video. For example, the analysis unit detects abnormalities in consideration of time-of-day information in the video. For example, the analysis unit comprehensively considers environmental information in the video to detect abnormalities. By considering environmental information in the video, more accurate abnormality detection is possible.

The analysis unit can learn abnormal patterns by comparing with past analysis data during analysis and improve detection accuracy. Abnormal patterns may include, for example, comparison with past data, machine learning algorithms, etc., but are not limited to such examples. For example, the analysis unit learns abnormal patterns based on past analysis data and improves detection accuracy. For example, the analysis unit compares past analysis data with real-time data to detect abnormalities. For example, the analysis unit utilizes past analysis data to perform early detection of abnormalities. By comparing with past analysis data, abnormal patterns can be learned and detection accuracy can be improved.

The notification unit can automatically summarize the notification content during notification and send only important information. Summarization may include, for example, methods for extracting highly important information, etc., but is not limited to such examples. For example, the notification unit automatically summarizes the notification content and sends only important information. For example, the notification unit summarizes the notification content concisely and emphasizes important information when sending. For example, the notification unit summarizes the notification content so that the user can quickly understand it. By summarizing the notification content, important information can be communicated quickly.

The notification unit can optimize the notification method according to the destination device during notification. Destination devices may include, for example, smartphones, tablets, PCs, etc., but are not limited to such examples. For example, when sending notifications to a smartphone, the notification unit uses push notifications. For example, when sending notifications to a tablet, the notification unit provides a notification method optimized for a large screen. For example, the notification unit automatically selects the optimal notification method according to the destination device. By providing the optimal notification method according to the destination device, prompt response is possible.

The notification unit can select the optimal notification method in consideration of the location information of the family or related parties at the notification destination during notification. Location information may include, for example, GPS, Wi-Fi location information, etc., but is not limited to such examples. For example, if family or related parties are nearby, the notification unit proposes a method of direct contact. For example, if family or related parties are far away, the notification unit proposes a method of notification by phone or message. For example, the notification unit automatically selects the optimal notification method based on the location information of family or related parties. By considering the location information of the notification destination, the optimal notification method can be selected.

The notification unit can support multilingual notification content during notification, enabling support for family members or related parties who speak different languages. Multilingual support may include, for example, the types of supported languages, translation algorithms, etc., but is not limited to such examples. For example, the notification unit automatically translates the notification content and sends it to family members or related parties who speak different languages. For example, the notification unit displays the notification content in multiple languages so that the user can select. For example, the notification unit supports multilingual notification content, enabling prompt response to family members or related parties who speak different languages. By supporting multilingual notification content, prompt response to family members or related parties who speak different languages is possible.

The system according to the embodiment is not limited to the above-described examples and can be variously modified, for example, as follows.

The wearable camera system may further comprise a battery management unit. The battery management unit monitors the remaining battery level of the camera and can switch to a power-saving mode as needed. For example, when the battery level drops, the recording frequency of the recording unit can be set lower and the transmission interval of the transmission unit can be extended. In addition, the battery management unit can optimize battery consumption based on the user's behavior patterns. For example, if the user is expected to be out for a long time, the settings can be automatically switched to reduce battery consumption. This extends battery life and maximizes system operating time.

The recording unit can adjust the frame rate of the video when recording video in real time from the user's point of view. For example, if the user is in a low-activity environment, the frame rate can be set lower to save data capacity. If the user is engaged in sports or active activities, the frame rate can be set higher to record smooth video. Furthermore, the recording unit can automatically adjust the frame rate according to the user's movements. This enables optimal video recording according to the situation.

The analysis unit can take weather information into account when analyzing the movement and location information of persons in the video. For example, in rainy weather, since visibility is poor, specific filtering techniques can be used to improve analysis accuracy. In addition, for analysis at night or in dark places, infrared cameras or low-light cameras can be used to improve analysis accuracy. Furthermore, the analysis unit can automatically adjust the analysis algorithm according to weather and time of day. This enables abnormality detection under various environmental conditions.

The notification unit can customize the notification content when sending notifications via a smartphone application. For example, the notification sound or vibration pattern can be changed according to the user's preferences. In addition, the notification content can be sent not only as text but also in a format including images or videos. Furthermore, the notification unit can learn from the user's past responses and propose the optimal notification method. This enables the most effective notifications for the user.

The recording unit can be worn when a child goes to school or when an elderly person goes for a walk, but can also automatically start recording according to specific events or activities. For example, when the user participates in a sports event, recording can automatically start to capture important moments. In addition, when the user arrives at a specific tourist spot during a trip, recording can automatically start. This enables recording according to specific events or activities.

The analysis unit can detect abnormalities when a child is approached by a suspicious person or when an elderly person leaves a specific area, and can also detect abnormalities in consideration of the user's health status. For example, if the user's heart rate rises sharply or body temperature becomes abnormally high, the analysis unit can detect an abnormality. In addition, the analysis unit can detect abnormalities if the user falls or remains motionless for a long time. This enables abnormality detection based on the user's health status.

The recording unit can analyze the user's behavior patterns during recording and automatically start recording when a specific behavior occurs, and can also adjust the timing for ending recording based on the user's behavior patterns. For example, the recording unit can automatically stop recording when the user leaves a specific area. In addition, the recording unit can stop recording when the user performs a specific gesture. This avoids unnecessary video recording and saves data capacity.

The recording unit can simultaneously record surrounding audio during recording and synchronize the video and audio, and can also automatically start recording when a specific audio pattern is detected. For example, if abnormal sounds such as screams or breaking glass are detected, recording can automatically start. In addition, recording can start when a conversation containing specific keywords is detected. This ensures that important audio events are not missed.

The following is a brief description of the processing flow of Example 1 of the Embodiment.

Step 1: The recording unit records video of a user wearing a wearable camera. For example, the recording unit records video in real time from the user's point of view. For example, the recording unit is worn when a child goes to school or when an elderly person goes for a walk.

Step 2: The transmission unit transmits the video recorded by the recording unit to a cloud server. For example, the transmission unit transmits video data to the cloud server in real time. The transmission unit can also estimate the user's emotions and adjust the timing of video transmission based on the estimated emotions.

Step 3: The analysis unit analyzes the video transmitted by the transmission unit and detects abnormal behavior or dangerous situations. For example, the analysis unit uses generative AI to analyze the movement and location information of persons in the video and detect abnormalities. For example, the analysis unit detects abnormalities when a child is approached by a suspicious person or when an elderly person leaves a specific area. The analysis unit can also estimate the user's emotions and adjust the priority of analysis based on the estimated emotions.

Step 4: The notification unit notifies the user's family or related parties of abnormalities or dangerous situations detected by the analysis unit. For example, the notification unit sends notifications via a smartphone application. The notification unit can also estimate the user's emotions and adjust the urgency of notifications based on the estimated emotions.

### Example 2 of the Embodiment

The wearable camera system according to the embodiment of the present invention is a system for crime prevention and for addressing wandering and missing elderly persons. In this wearable camera system, the user wears a wearable camera and, during daily life, records video in real time from the user's point of view and transmits it to a cloud server. The cloud server analyzes the transmitted video and detects abnormal behavior or dangerous situations. For example, this includes cases where a child is approached by a suspicious person or an elderly person leaves a specific area. The detected abnormalities or dangerous situations are immediately notified to the user's family or related parties. This enables prompt response, thereby achieving crime prevention and ensuring the safety of the elderly. For example, a user wearing a wearable camera goes about daily life. This camera records video in real time from the user's point of view and transmits it to a cloud server. For example, it may be worn when a child goes to school or when an elderly person goes for a walk. Next, the cloud server analyzes the transmitted video. Using generative AI, abnormal behavior or dangerous situations in the video are detected. For example, this includes cases where a child is approached by a suspicious person or an elderly person leaves a specific area. The generative AI analyzes the movement and location information of persons in the video to detect abnormalities. The detected abnormalities or dangerous situations are immediately notified to the user's family or related parties. For example, notifications are sent via a smartphone application. This allows family members or related parties to respond quickly. For example, if a child is approached by a suspicious person, the family can immediately report it to the police. Also, if an elderly person leaves a specific area, the family can immediately start a search. Through this mechanism, crime prevention and ensuring the safety of the elderly are achieved. By wearing a wearable camera, the user's actions are constantly monitored, which deters suspicious persons from committing crimes. In addition, the risk of elderly persons wandering and going missing is reduced. For example, if an elderly person wearing a wearable camera leaves a specific area, the family can immediately identify the location and respond quickly. Thus, the wearable camera system enables crime prevention and ensuring the safety of the elderly by recording, transmitting, analyzing, and notifying the user's video.

The wearable camera system according to the embodiment comprises a recording unit, a transmission unit, an analysis unit, and a notification unit. The recording unit records video of a user wearing a wearable camera. For example, the recording unit records video in real time from the user's point of view. For example, the recording unit is worn when a child goes to school or when an elderly person goes for a walk. The transmission unit transmits the video recorded by the recording unit to a cloud server. For example, the transmission unit transmits video data to the cloud server in real time. The transmission unit can also estimate the user's emotions and adjust the timing of video transmission based on the estimated emotions. The analysis unit analyzes the video transmitted by the transmission unit and detects abnormal behavior or dangerous situations. For example, the analysis unit uses generative AI to analyze the movement and location information of persons in the video and detect abnormalities. For example, the analysis unit detects abnormalities when a child is approached by a suspicious person or when an elderly person leaves a specific area. The analysis unit can also estimate the user's emotions and adjust the priority of analysis based on the estimated emotions. The notification unit notifies the user's family or related parties of abnormalities or dangerous situations detected by the analysis unit. For example, the notification unit sends notifications via a smartphone application. The notification unit can also estimate the user's emotions and adjust the urgency of notifications based on the estimated emotions. Thus, the wearable camera system enables crime prevention and ensuring the safety of the elderly by recording, transmitting, analyzing, and notifying the user's video.

The recording unit can record video in real time from the user's point of view. Real time may include, for example, a delay time of less than one second, but is not limited to such examples. For example, the recording unit records video in real time from the user's point of view. For example, the recording unit records video in real time from the user's point of view. For example, the recording unit records video in real time from the user's point of view. By recording video in real time from the user's point of view, more accurate situational awareness can be achieved.

The analysis unit can analyze the movement and location information of persons in the video and detect abnormalities. Movements may include, for example, speed, direction, patterns, etc., but are not limited to such examples. Location information may include, for example, GPS, Wi-Fi location information, etc., but is not limited to such examples. For example, the analysis unit analyzes the movement and location information of persons in the video and detects abnormalities. For example, the analysis unit analyzes the movement and location information of persons in the video and detects abnormalities. For example, the analysis unit analyzes the movement and location information of persons in the video and detects abnormalities. By analyzing the movement and location information of persons in the video, abnormal behavior or dangerous situations can be detected quickly.

The notification unit can send notifications via a smartphone application. The smartphone application may include, for example, notification functions, alert functions, etc., but is not limited to such examples. For example, the notification unit sends notifications via a smartphone application. For example, the notification unit sends notifications via a smartphone application. For example, the notification unit sends notifications via a smartphone application. By sending notifications via a smartphone application, family members or related parties can respond quickly.

The recording unit can be worn when a child goes to school or when an elderly person goes for a walk. Children may include, for example, minors, specific age groups, etc., but are not limited to such examples. Elderly persons may include, for example, those aged 65 or older, 75 or older, etc., but are not limited to such examples. For example, the recording unit is worn when a child goes to school. For example, the recording unit is worn when an elderly person goes for a walk. For example, the recording unit is worn when a child goes to school. By wearing the device when children or elderly persons perform specific actions, safety is improved.

The analysis unit can detect abnormalities when a child is approached by a suspicious person or when an elderly person leaves a specific area. Suspicious persons may include, for example, strangers, specific behavior patterns, etc., but are not limited to such examples. Specific areas may include, for example, the area around the home, designated safe areas, etc., but are not limited to such examples. For example, the analysis unit detects abnormalities when a child is approached by a suspicious person. For example, the analysis unit detects abnormalities when an elderly person leaves a specific area. For example, the analysis unit detects abnormalities when a child is approached by a suspicious person. By detecting specific abnormal behaviors, prompt response is enabled.

The recording unit can estimate the user's emotions and adjust the recording frequency of the video based on the estimated emotions. Emotions may include, for example, facial expression analysis, voice analysis, etc., but are not limited to such examples. For example, if the user is nervous, the recording frequency is increased to record detailed video. For example, if the user is relaxed, the recording frequency is decreased to record only necessary scenes. For example, if the user is excited, the recording frequency is set to a medium level to avoid missing important scenes. By adjusting the recording frequency according to the user's emotions, important scenes can be reliably recorded.

The recording unit can analyze the user's behavior patterns during recording and automatically start recording when a specific behavior occurs. Behavior patterns may include, for example, daily routines, specific actions, etc., but are not limited to such examples. For example, the recording unit automatically starts recording when the user enters a specific area. For example, the recording unit automatically starts recording when the user performs a specific gesture. For example, the recording unit automatically starts recording when the user performs a specific action at a specific time of day. By automatically starting recording when a specific behavior occurs, important scenes can be reliably recorded.

The recording unit can simultaneously record surrounding audio during recording and synchronize the video and audio. Surrounding audio may include, for example, types of microphones, voice recognition technology, etc., but is not limited to such examples. For example, the recording unit records video and audio simultaneously and synchronizes them for playback later. For example, the recording unit analyzes surrounding audio in real time and emphasizes important audio for recording. For example, the recording unit automatically synchronizes video and audio to ensure seamless playback. By synchronizing video and audio, more accurate situational awareness can be achieved.

The recording unit can estimate the user's emotions and adjust the resolution of the recorded video based on the estimated emotions. Resolution may include, for example, HD, 4K, and other resolution settings, but is not limited to such examples. For example, if the user is nervous, recording is performed in high resolution to provide detailed video. For example, if the user is relaxed, recording is performed in low resolution to save data capacity. For example, if the user is excited, recording is performed in medium resolution to provide balanced video. By adjusting the video resolution according to the user's emotions, appropriate video quality can be provided.

The recording unit can simultaneously record the user's location information during recording and link the video with the location information. Location information may include, for example, GPS, Wi-Fi location information, etc., but is not limited to such examples. For example, the recording unit records GPS data together with the video and displays the location information during playback. For example, the recording unit records the user's movement route and plays it back linked with the video. For example, the recording unit emphasizes and records location information when the user enters a specific area. By linking video and location information, the location can be displayed during playback.

The recording unit can simultaneously record the user's health status (such as heart rate and body temperature) during recording and issue an alert if an abnormality is detected. Health status may include, for example, heart rate, body temperature, blood pressure, etc., but is not limited to such examples. For example, the recording unit issues an alert if the user's heart rate is abnormally high. For example, the recording unit issues an alert if the user's body temperature is abnormally low. For example, the recording unit immediately issues an alert if the user's health status changes suddenly. By monitoring the user's health status, prompt response is possible when an abnormality is detected.

The transmission unit can estimate the user's emotions and adjust the timing of video transmission based on the estimated emotions. Emotions may include, for example, facial expression analysis, voice analysis, etc., but are not limited to such examples. For example, if the user is nervous, the video is transmitted immediately. For example, if the user is relaxed, the video is transmitted at regular intervals. For example, if the user is excited, the video is transmitted frequently. By adjusting the transmission timing according to the user's emotions, video can be transmitted at appropriate times.

The transmission unit can adjust the compression rate of video data during transmission to optimize the transmission speed. Compression rate may include, for example, bit rate, compression algorithms, etc., but is not limited to such examples. For example, the transmission unit adjusts the compression rate according to network conditions to ensure optimal transmission speed. For example, the transmission unit adjusts the compression rate according to the importance of the video to ensure that necessary information is reliably transmitted. For example, the transmission unit adjusts the compression rate according to the user's emotions to provide an appropriate transmission speed. By adjusting the compression rate of video data, optimal transmission speed can be ensured.

The transmission unit can select the transmission route in consideration of the load status of the destination cloud server during transmission. Load status may include, for example, CPU usage, memory usage, etc., but is not limited to such examples. For example, if the cloud server is heavily loaded, the transmission unit transmits to another server. For example, the transmission unit monitors the load status of the cloud server in real time and selects the optimal transmission route. For example, the transmission unit uses multiple cloud servers and transmits while performing load balancing. By considering the load status of the cloud server, the optimal transmission route can be selected.

The transmission unit can estimate the user's emotions and determine the priority of the video to be transmitted based on the estimated emotions. Emotions may include, for example, facial expression analysis, voice analysis, etc., but are not limited to such examples. For example, if the user is nervous, important video is transmitted with priority. For example, if the user is relaxed, normal video is transmitted. For example, if the user is excited, specific video is transmitted with priority. By determining the priority of video according to the user's emotions, important video can be transmitted with priority.

The transmission unit can select the transmission method in consideration of the user's network connection status during transmission. Network connection status may include, for example, Wi-Fi signal strength, mobile data speed, etc., but is not limited to such examples. For example, if Wi-Fi is available, the transmission unit prioritizes Wi-Fi for transmission. For example, if the mobile data connection is stable, the transmission unit uses mobile data for transmission. For example, the transmission unit automatically selects the optimal transmission method according to the network connection status. By selecting the optimal transmission method according to the network connection status, stable transmission is possible.

The transmission unit can encrypt video data during transmission to ensure data security during transmission. Encryption may include, for example, encryption algorithms such as AES, RSA, etc., but is not limited to such examples. For example, the transmission unit encrypts video data before transmission to protect data during transmission. For example, the transmission unit uses encryption algorithms to protect data during transmission from third parties. For example, the transmission unit automatically encrypts and decrypts video data to ensure security. By encrypting video data, data security during transmission can be ensured.

The analysis unit can estimate the user's emotions and adjust the priority of analysis based on the estimated emotions. Emotions may include, for example, facial expression analysis, voice analysis, etc., but are not limited to such examples. For example, if the user is nervous, the priority of analysis is increased to quickly detect abnormalities. For example, if the user is relaxed, analysis is performed with normal priority. For example, if the user is excited, specific analysis is performed with priority. By adjusting the priority of analysis according to the user's emotions, abnormalities can be detected quickly.

The analysis unit can perform object recognition in the video during analysis and issue an alert when a specific object appears in the video. Object recognition may include, for example, image recognition algorithms, definitions of specific objects, etc., but is not limited to such examples. For example, the analysis unit issues an alert when a suspicious object appears in the video. For example, the analysis unit issues an alert when a specific person appears in the video. For example, the analysis unit issues an alert when a dangerous object appears in the video. By performing object recognition in the video, an alert can be issued promptly when a specific object appears.

The analysis unit can perform audio analysis in the video during analysis and detect specific audio patterns. Audio patterns may include, for example, screams, the sound of breaking glass, etc., but are not limited to such examples. For example, the analysis unit detects screams in the video and issues an alert. For example, the analysis unit detects abnormal audio patterns in the video and issues an alert. For example, the analysis unit detects specific audio patterns in the video and issues an alert. By performing audio analysis in the video, specific audio patterns can be detected and responded to promptly.

The analysis unit can estimate the user's emotions and adjust the display method of analysis results based on the estimated emotions. Emotions may include, for example, facial expression analysis, voice analysis, etc., but are not limited to such examples. For example, if the user is nervous, a simple and highly visible display method is provided. For example, if the user is relaxed, a display method including detailed information is provided. For example, if the user is in a hurry, a display method focusing on key points is provided. By adjusting the display method of analysis results according to the user's emotions, visibility is improved.

The analysis unit can detect abnormalities in consideration of environmental information in the video during analysis. Environmental information may include, for example, weather, time of day, temperature, etc., but is not limited to such examples. For example, the analysis unit detects abnormalities in consideration of weather information in the video. For example, the analysis unit detects abnormalities in consideration of time-of-day information in the video. For example, the analysis unit comprehensively considers environmental information in the video to detect abnormalities. By considering environmental information in the video, more accurate abnormality detection is possible.

The analysis unit can learn abnormal patterns by comparing with past analysis data during analysis and improve detection accuracy. Abnormal patterns may include, for example, comparison with past data, machine learning algorithms, etc., but are not limited to such examples. For example, the analysis unit learns abnormal patterns based on past analysis data and improves detection accuracy. For example, the analysis unit compares past analysis data with real-time data to detect abnormalities. For example, the analysis unit utilizes past analysis data to perform early detection of abnormalities. By comparing with past analysis data, abnormal patterns can be learned and detection accuracy can be improved.

The notification unit can estimate the user's emotions and adjust the urgency of notifications based on the estimated emotions. Emotions may include, for example, facial expression analysis, voice analysis, etc., but are not limited to such examples. For example, if the user is nervous, high-urgency notifications are sent with priority. For example, if the user is relaxed, normal notifications are sent. For example, if the user is excited, specific notifications are sent with priority. By adjusting the urgency of notifications according to the user's emotions, appropriate response is possible.

The notification unit can automatically summarize the notification content during notification and send only important information. Summarization may include, for example, methods for extracting highly important information, etc., but is not limited to such examples. For example, the notification unit automatically summarizes the notification content and sends only important information. For example, the notification unit summarizes the notification content concisely and emphasizes important information when sending. For example, the notification unit summarizes the notification content so that the user can quickly understand it. By summarizing the notification content, important information can be communicated quickly.

The notification unit can optimize the notification method according to the destination device during notification. Destination devices may include, for example, smartphones, tablets, PCs, etc., but are not limited to such examples. For example, when sending notifications to a smartphone, the notification unit uses push notifications. For example, when sending notifications to a tablet, the notification unit provides a notification method optimized for a large screen. For example, the notification unit automatically selects the optimal notification method according to the destination device. By providing the optimal notification method according to the destination device, prompt response is possible.

The notification unit can estimate the user's emotions and adjust the display method of notifications based on the estimated emotions. Emotions may include, for example, facial expression analysis, voice analysis, etc., but are not limited to such examples. For example, if the user is nervous, a simple and highly visible display method is provided. For example, if the user is relaxed, a display method including detailed information is provided. For example, if the user is in a hurry, a display method focusing on key points is provided. By adjusting the display method of notifications according to the user's emotions, visibility is improved.

The notification unit can select the optimal notification method in consideration of the location information of the family or related parties at the notification destination during notification. Location information may include, for example, GPS, Wi-Fi location information, etc., but is not limited to such examples. For example, if family or related parties are nearby, the notification unit proposes a method of direct contact. For example, if family or related parties are far away, the notification unit proposes a method of notification by phone or message. For example, the notification unit automatically selects the optimal notification method based on the location information of family or related parties. By considering the location information of the notification destination, the optimal notification method can be selected.

The notification unit can support multilingual notification content during notification, enabling support for family members or related parties who speak different languages. Multilingual support may include, for example, the types of supported languages, translation algorithms, etc., but is not limited to such examples. For example, the notification unit automatically translates the notification content and sends it to family members or related parties who speak different languages. For example, the notification unit displays the notification content in multiple languages so that the user can select. For example, the notification unit supports multilingual notification content, enabling prompt response to family members or related parties who speak different languages. By supporting multilingual notification content, prompt response to family members or related parties who speak different languages is possible.

### ===Hardware Support 1-1===

Each of the above-described elements, including the recording unit, transmission unit, analysis unit, and notification unit, is implemented by at least one of, for example, the smart device 14 and the data processing device 12. For example, the recording unit records video in real time from the user's point of view using the camera 42 of the smart device 14. The transmission unit transmits video data to the cloud server via the communication I/F 44 of the smart device 14. The analysis unit analyzes the transmitted video using the specific processing unit 290 of the data processing device 12 and detects abnormal behavior or dangerous situations. The notification unit notifies the user's family or related parties of abnormalities or dangerous situations detected by the specific processing unit 290 of the data processing device 12.

### ===Hardware Support 1-2===

Each of the above-described elements, including the recording unit, transmission unit, analysis unit, and notification unit, is implemented by at least one of, for example, the smart glasses 214 and the data processing device 12. For example, the recording unit records video in real time from the user's point of view using the camera 42 of the smart glasses 214. The transmission unit transmits video data to the cloud server via the communication I/F 44 of the smart glasses 214. The analysis unit analyzes the transmitted video using the specific processing unit 290 of the data processing device 12 and detects abnormal behavior or dangerous situations. The notification unit notifies the user's family or related parties of abnormalities or dangerous situations detected by the specific processing unit 290 of the data processing device 12.

### ===Hardware Support 1-3===

Each of the above-described elements, including the recording unit, transmission unit, analysis unit, and notification unit, is implemented by at least one of, for example, the headset-type terminal 314 and the data processing device 12. For example, the recording unit records video in real time from the user's point of view using the camera 42 of the headset-type terminal 314. The transmission unit transmits video data to the cloud server via the communication I/F 44 of the headset-type terminal 314. The analysis unit analyzes the transmitted video using the specific processing unit 290 of the data processing device 12 and detects abnormal behavior or dangerous situations. The notification unit notifies the user's family or related parties of abnormalities or dangerous situations detected by the specific processing unit 290 of the data processing device 12.

### ===Hardware Support 1-4===

Each of the above-described elements, including the recording unit, transmission unit, analysis unit, and notification unit, is implemented by at least one of, for example, the robot 414 and the data processing device 12. For example, the recording unit records video in real time from the user's point of view using the camera 42 of the robot 414. The transmission unit transmits video data to the cloud server via the communication I/F 44 of the robot 414. The analysis unit analyzes the transmitted video using the specific processing unit 290 of the data processing device 12 and detects abnormal behavior or dangerous situations. The notification unit notifies the user's family or related parties of abnormalities or dangerous situations detected by the specific processing unit 290 of the data processing device 12.

The system according to the embodiment is not limited to the above-described examples and can be variously modified, for example, as follows.

The wearable camera system may further comprise a battery management unit. The battery management unit monitors the remaining battery level of the camera and can switch to a power-saving mode as needed. For example, when the battery level drops, the recording frequency of the recording unit can be set lower and the transmission interval of the transmission unit can be extended. In addition, the battery management unit can optimize battery consumption based on the user's behavior patterns. For example, if the user is expected to be out for a long time, the settings can be automatically switched to reduce battery consumption. This extends battery life and maximizes system operating time.

The recording unit can adjust the frame rate of the video when recording video in real time from the user's point of view. For example, if the user is in a low-activity environment, the frame rate can be set lower to save data capacity. If the user is engaged in sports or active activities, the frame rate can be set higher to record smooth video. Furthermore, the recording unit can automatically adjust the frame rate according to the user's movements. This enables optimal video recording according to the situation.

The analysis unit can take weather information into account when analyzing the movement and location information of persons in the video. For example, in rainy weather, since visibility is poor, specific filtering techniques can be used to improve analysis accuracy. In addition, for analysis at night or in dark places, infrared cameras or low-light cameras can be used to improve analysis accuracy. Furthermore, the analysis unit can automatically adjust the analysis algorithm according to weather and time of day. This enables abnormality detection under various environmental conditions.

The notification unit can customize the notification content when sending notifications via a smartphone application. For example, the notification sound or vibration pattern can be changed according to the user's preferences. In addition, the notification content can be sent not only as text but also in a format including images or videos. Furthermore, the notification unit can learn from the user's past responses and propose the optimal notification method. This enables the most effective notifications for the user.

The recording unit can be worn when a child goes to school or when an elderly person goes for a walk, but can also automatically start recording according to specific events or activities. For example, when the user participates in a sports event, recording can automatically start to capture important moments. In addition, when the user arrives at a specific tourist spot during a trip, recording can automatically start. This enables recording according to specific events or activities.

The analysis unit can detect abnormalities when a child is approached by a suspicious person or when an elderly person leaves a specific area, and can also detect abnormalities in consideration of the user's health status. For example, if the user's heart rate rises sharply or body temperature becomes abnormally high, the analysis unit can detect an abnormality. In addition, the analysis unit can detect abnormalities if the user falls or remains motionless for a long time. This enables abnormality detection based on the user's health status.

The recording unit can estimate the user's emotions and adjust the recording frequency of the video based on the estimated emotions, and can further adjust the resolution of the recorded video based on the user's emotions. For example, if the user is nervous, recording can be performed in high resolution to provide detailed video. In addition, if the user is relaxed, recording can be performed in low resolution to save data capacity. This enables optimal video recording according to the user's emotions.

The recording unit can analyze the user's behavior patterns during recording and automatically start recording when a specific behavior occurs, and can also adjust the timing for ending recording based on the user's behavior patterns. For example, the recording unit can automatically stop recording when the user leaves a specific area. In addition, the recording unit can stop recording when the user performs a specific gesture. This avoids unnecessary video recording and saves data capacity.

The recording unit can simultaneously record surrounding audio during recording and synchronize the video and audio, and can also automatically start recording when a specific audio pattern is detected. For example, if abnormal sounds such as screams or breaking glass are detected, recording can automatically start. In addition, recording can start when a conversation containing specific keywords is detected. This ensures that important audio events are not missed.

The recording unit can estimate the user's emotions and adjust the resolution of the recorded video based on the estimated emotions, and can further adjust the color tone of the recorded video based on the user's emotions. For example, if the user is nervous, the color tone can be made vivid to provide detailed video. In addition, if the user is relaxed, the color tone can be set to a calm tone for recording. This enables optimal video recording according to the user's emotions.

The following is a brief description of the processing flow of Example 2 of the Embodiment.

Step 1: The recording unit records video of a user wearing a wearable camera. For example, the recording unit records video in real time from the user's point of view. For example, the recording unit is worn when a child goes to school or when an elderly person goes for a walk.

Step 2: The transmission unit transmits the video recorded by the recording unit to a cloud server. For example, the transmission unit transmits video data to the cloud server in real time. The transmission unit can also estimate the user's emotions and adjust the timing of video transmission based on the estimated emotions.

Step 3: The analysis unit analyzes the video transmitted by the transmission unit and detects abnormal behavior or dangerous situations. For example, the analysis unit uses generative AI to analyze the movement and location information of persons in the video and detect abnormalities. For example, the analysis unit detects abnormalities when a child is approached by a suspicious person or when an elderly person leaves a specific area. The analysis unit can also estimate the user's emotions and adjust the priority of analysis based on the estimated emotions.

Step 4: The notification unit notifies the user's family or related parties of abnormalities or dangerous situations detected by the analysis unit. For example, the notification unit sends notifications via a smartphone application. The notification unit can also estimate the user's emotions and adjust the urgency of notifications based on the estimated emotions.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

The correspondence between each unit and the device or control unit is not limited to the above-described examples and can be variously modified.

### Second Embodiment

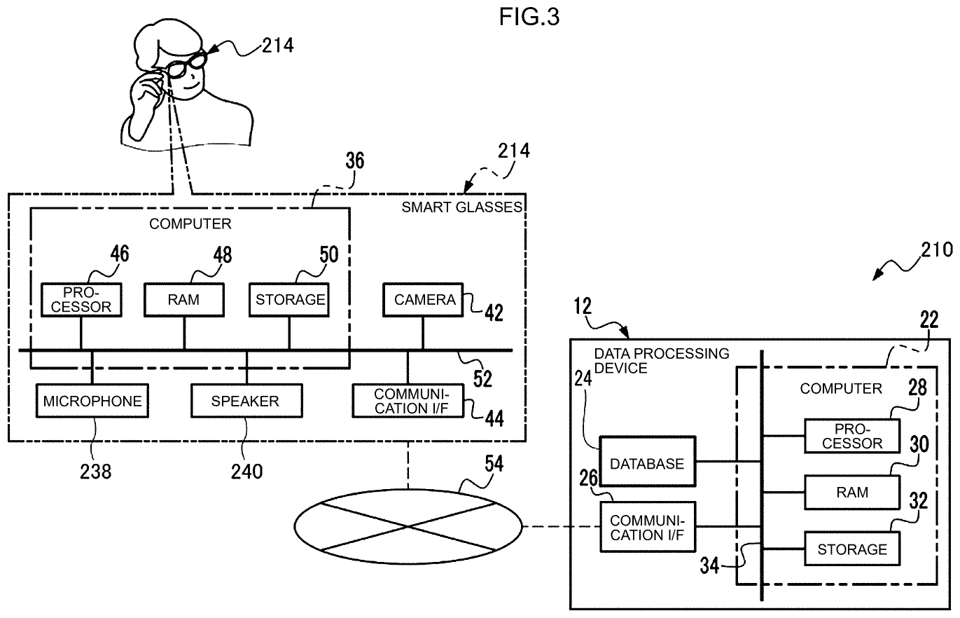

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

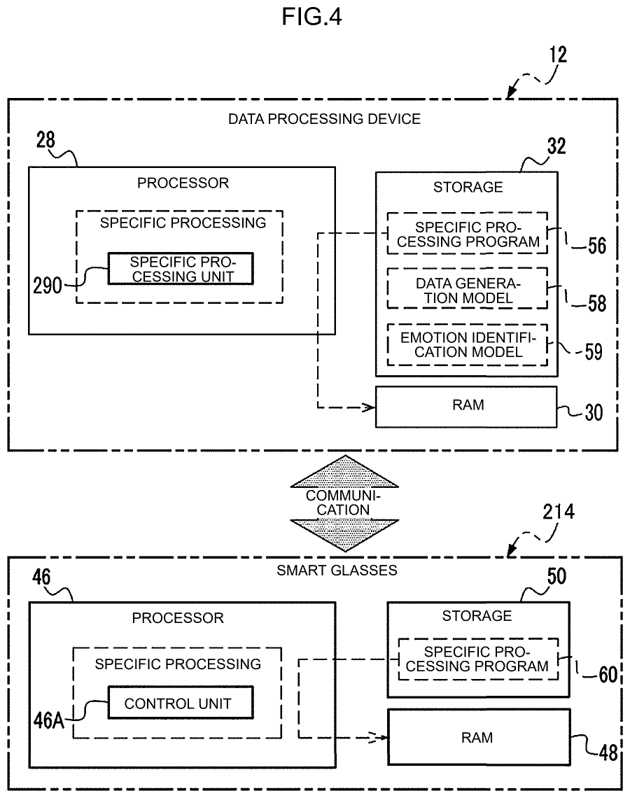

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

The correspondence between each unit and the device or control unit is not limited to the above-described examples and can be variously modified.

### Third Embodiment

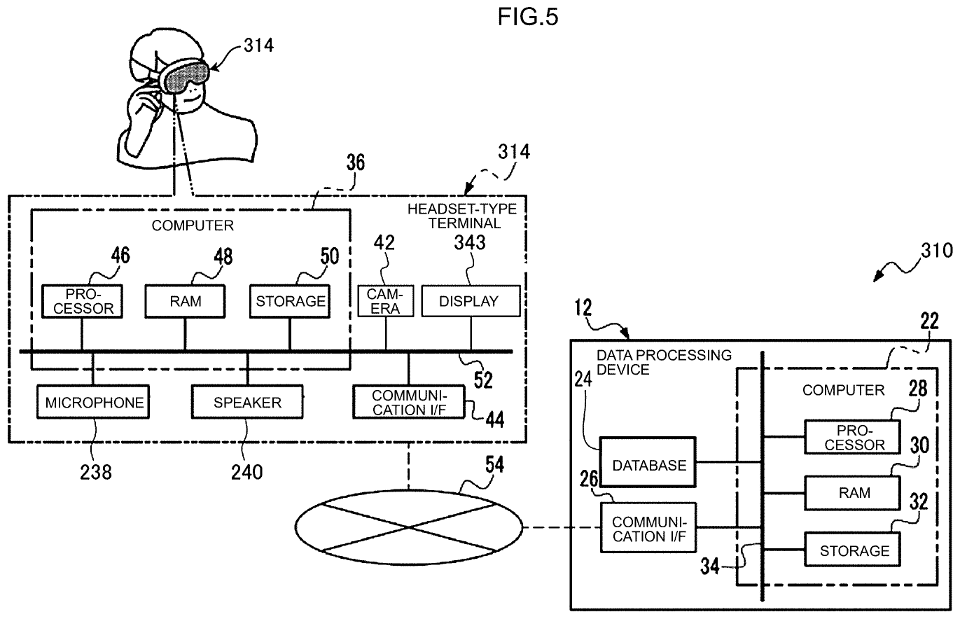

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

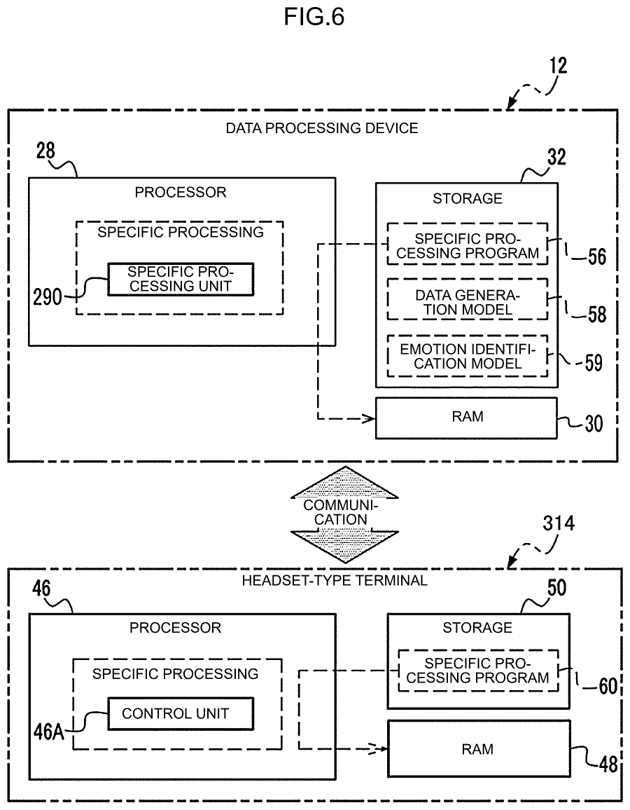

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

The correspondence between each unit and the device or control unit is not limited to the above-described examples and can be variously modified.

### Fourth Embodiment

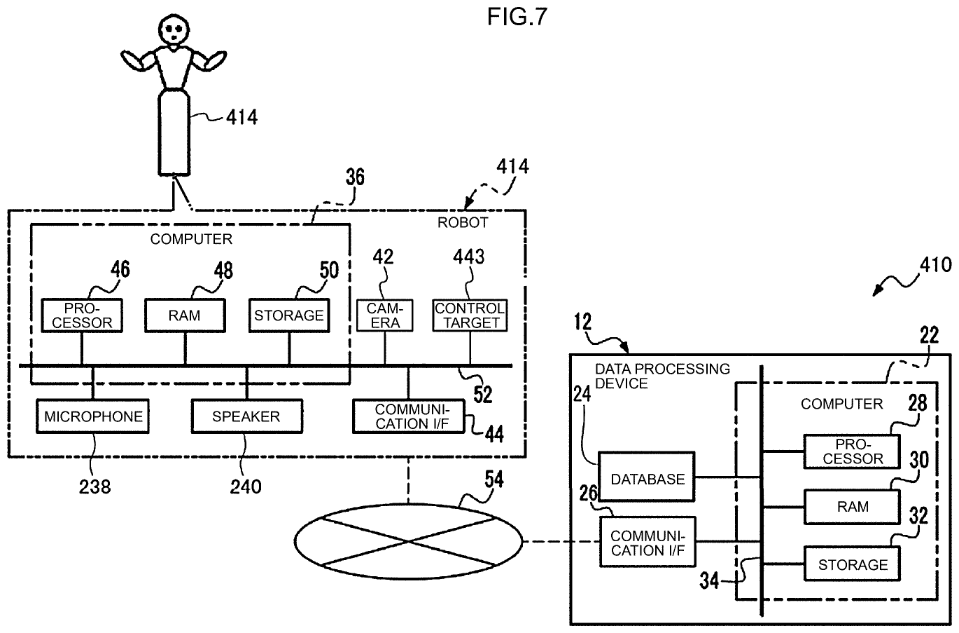

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

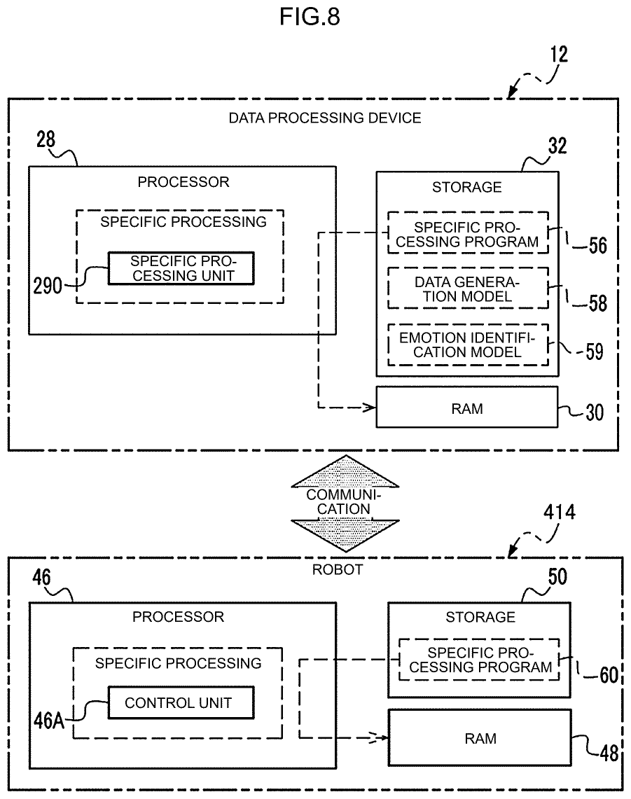

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

The correspondence between each unit and the device or control unit is not limited to the above-described examples and can be variously modified.

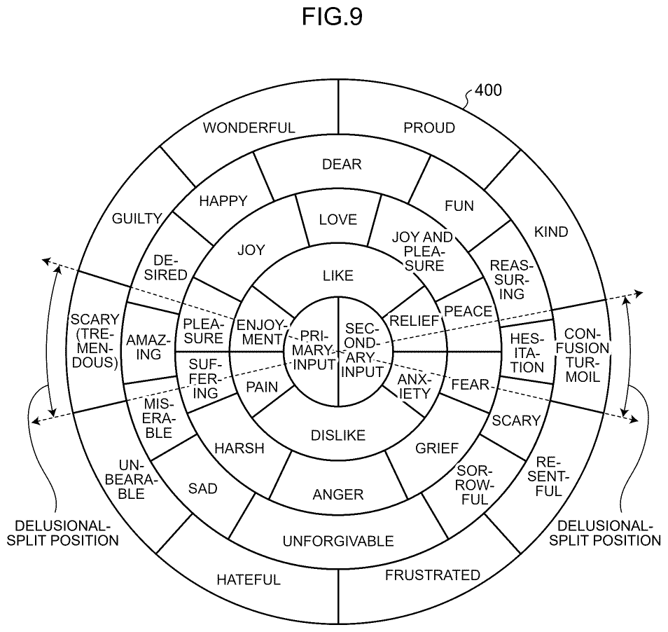

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

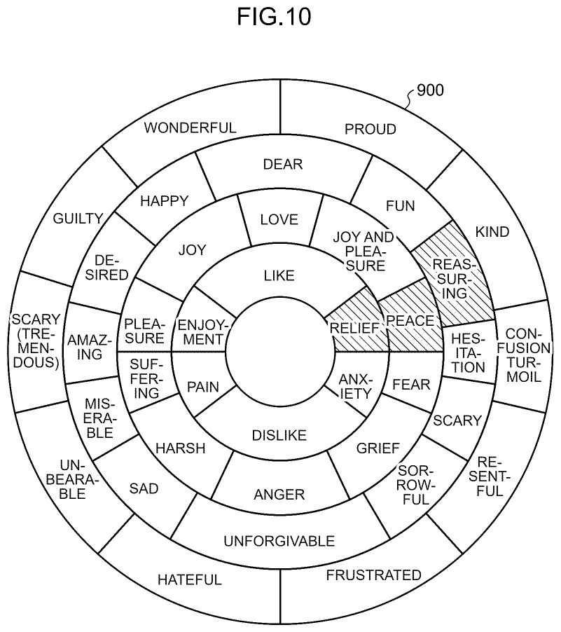

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used. Additionally, the examples described above were explained by dividing into form example 1 and form example 2, but these may be combined.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

What is claimed is:

1. A system comprising: a recording unit that records video of a user wearing a wearable camera; a transmission unit that transmits the video recorded by the recording unit to a cloud server; an analysis unit that analyzes the video transmitted by the transmission unit and detects abnormal behavior or dangerous situations; and a notification unit that notifies the user's family or related parties of abnormalities or dangerous situations detected by the analysis unit.

2. The system according to claim 1, wherein the recording unit records video in real time from the user's point of view.

3. The system according to claim 1, wherein the analysis unit analyzes the movement and location information of persons in the video to detect abnormalities.

4. The system according to claim 1, wherein the notification unit sends notifications via a smartphone application.

5. The system according to claim 1, wherein the recording unit is worn when a child goes to school or when an elderly person goes for a walk.

6. The system according to claim 1, wherein the analysis unit detects abnormalities when a child is approached by a suspicious person or when an elderly person leaves a specific area.

7. The system according to claim 1, wherein the recording unit estimates the user's emotions and adjusts the recording frequency of the video based on the estimated emotions.

8. The system according to claim 1, wherein the recording unit analyzes the user's behavior patterns during recording and automatically starts recording when a specific behavior occurs.

9. The system according to claim 1, wherein the recording unit simultaneously records surrounding audio during recording and synchronizes the video and audio.

10. The system according to claim 1, wherein the recording unit estimates the user's emotions and adjusts the resolution of the recorded video based on the estimated emotions.
